(19) United States
(12) Patent Application Publication
(10) Pub. No.: US 2012/0150908 A1
(43) Pub. Date: Jun. 14, 2012

(54) MICROBLOG-BASED CUSTOMER SUPPORT

(75) Inventor: McKenzie Eakin, Redmond, WA (US)

(73) Assignee: MICROSOFT CORPORATION, Redmond, WA (US)

(21) Appl. No.: 12/964,582

(22) Filed: Dec. 9, 2010

(51) Int. Cl. G06F 15/16; G06F 17/30

(52) U.S. Cl. 707/770; 709/206; 707/E17.014; 707/E17.108

(57) ABSTRACT

Embodiments are disclosed that relate to microblog-based customer support. One embodiment provides a method comprising receiving a stream of microblog messages including two or more microblog messages received at a designated microblog address associated with customer support, and sorting the stream of microblog messages into two or more different pools based on preselected criteria. The method further comprises receiving an input of a first microblog reply to a first microblog message of a first pool, and sending the first microblog reply via the designated microblog address associated with customer support. The method further comprises receiving an input of a second microblog reply to a second microblog message of a second pool different than the first pool, and sending the second microblog reply via the designated microblog address associated with customer support.

### BACKGROUND

Microblogging is a form of communication in which users may send or distribute relatively succinct electronic messages to other users. As with traditional blogging, a user may post a microblog message to the user's own microblog address for access by others who follow that user. Further, a user may also receive person-to-person microblog messages sent to their microblog address from other users. Microblog messages may be sent/received via a computer, laptop, portable device, mobile phone, or any other suitable device via any suitable communication protocol, including but not limited to Short Message Service (SMS) protocol.

### SUMMARY

Various embodiments are disclosed herein that relate to microblog-based customer support. For example, one disclosed embodiment provides, on a server, a method comprising receiving a stream of microblog messages at a designated microblog address associated with customer support, and sorting the stream of microblog messages into two or more different pools based on preselected criteria. The method further comprises receiving an input of a first microblog reply to a first microblog message of a first pool, and sending the first microblog reply via the designated microblog address associated with customer support. The method further comprises receiving an input of a second microblog reply to a second microblog message of a second pool different than the first pool, and sending the second microblog reply via the designated microblog address associated with customer support.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 shows an example use environment in accordance with an embodiment of the present disclosure.

FIG. 2 shows an example process flow in accordance with an embodiment of the present disclosure.

### DETAILED DESCRIPTION

Due to the ease of communicating via microblogging services, microblogging is becoming an ever more popular method for users to distribute messages to groups of people and/or to send messages to other users. Microblogging applications allow users to post, send and receive microblog messages via a wide array of devices, including but not limited to desktop computers, laptop computers, tablet computers, mobile phones, etc. Such flexibility allows users to remain relatively “connected,” as a microblogging-enabled device may often be close at hand. The resulting ability to receive quick responses to posted or sent messages may lead many users to find microblogging to be a desirable way of communicating.

From a customer support standpoint, rapid receipt of and response to consumer inquiries and/or complaints may make the difference between a happy customer and an unhappy customer. However, the use of microblogging as a customer support communication tool has been limited. For example, some implementations of microblog-based customer support utilize multiple employees each receiving messages at and responding from a different microblogging address than other customer support employees. As such, a customer who wishes to submit a request must first determine a microblogging address of a customer support representative, and then address the inquiry to that specific address. However, as such addresses are often personal to specific employees, it may be difficult to get a response if the employee is on vacation or otherwise not at work, thus requiring the customer to seek out another employee's microblogging address to re-send the inquiry. This may make it difficult to ensure the continuity of the customer support experience, where one customer support employee may not have ready access to another customer support employee's microblog communication history.

Therefore, embodiments are disclosed herein that relate to microblog-based customer support, wherein customer support inquiries received at a designated microblog address are sorted into parallel pools to allow multiple employees to work in parallel to address and respond to the inquiries. Likewise, responses from multiple employees are sent to customers from the same designated microblog address. The sorting of incoming messages into pools may facilitate the continuity of the customer support experience, as inquiries from a selected customer may be directed to the same pool, regardless of the employee monitoring the pool. Additionally, a customer may choose to follow the designated microblog address used for customer support inquiries, and therefore may receive postings that the company makes to that address to learn about product notifications, service notifications, news, etc. It will be understood that the term “designated microblog address” and the like as used herein signifies a common microblog address utilized by multiple customer support employees for a common type of customer interaction, and that a company in some circumstances may have plural different “designated” microblog addresses, for example, for different types of customer inquiries and/or different organizations within the company

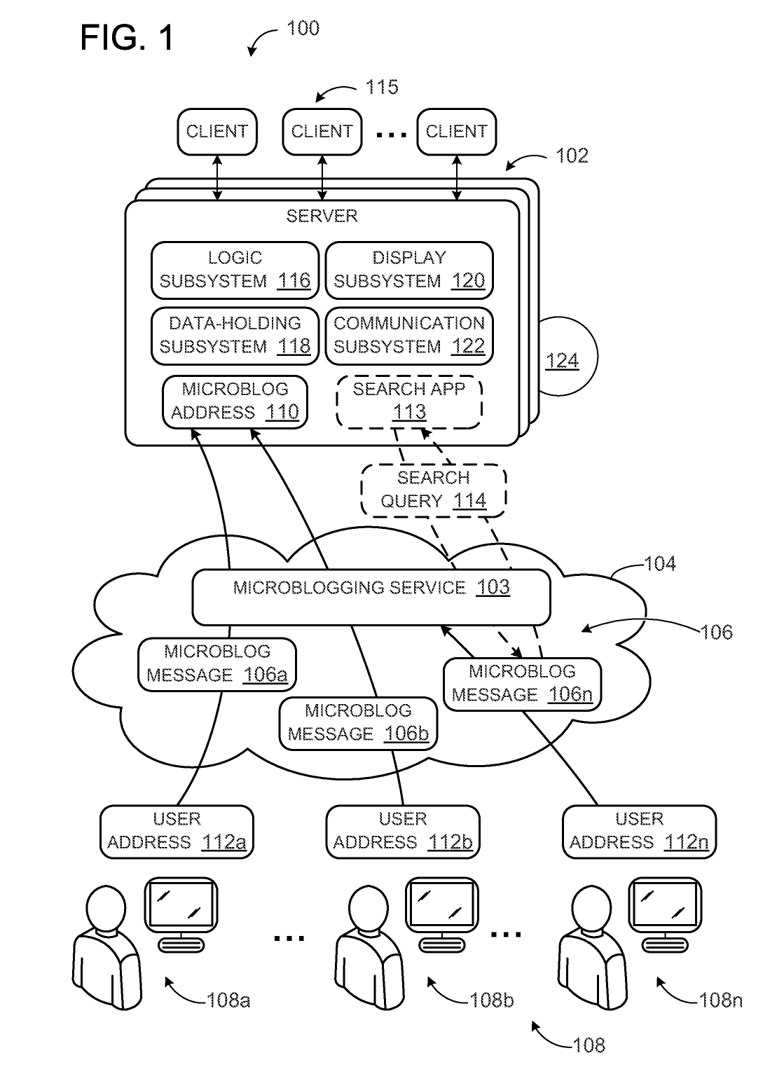

FIG. 1 shows an example use environment 100 for microblog-based customer support. Use environment 100 comprises a server system 102 configured to receive, process, and send microblog messages via a microblogging service 103. In the depicted embodiment, the microblogging service 103 is shown as being a cloud-based service accessible via a network 104, but in other embodiments the microblogging service may be local to server system 102. It will be appreciated that server system 102 may comprise a single server device or multiple server devices communicatively coupled with one another.

Server system 102 is configured to receive microblog messages 106 sent by one or more customer users 108 via microblogging service 103. Such messages may take the form of customer support inquiries sent by a user 108 to a microblog address 110 known by the customer to be a designated customer support communication address. This scenario is depicted in FIG. 1 as a first user 108a sending a microblog message 106a from the first user's microblog address 112a to the server's microblog address 110 via microblogging service 103, and a second user 108b sending a microblog message 106b from the second user's microblog address 112b to microblog address 110 via microblogging service 103.

In some embodiments, a company also may perform searches to locate customer messages or postings made or sent by users that relate to product or customer support issues relevant to the company, but that are not sent directly to the company. Thus, as illustrated in FIG. 1, server system 102 may optionally comprise a search application 113 configured to send search queries to microblogging service 103 to locate and download microblog messages via searching. Any suitable searching may be performed to locate and download relevant microblog messages. As an example, keyword searching may be performed on the content of publicly available microblog messages, wherein such keyword searching may include names of products and/or services of interest. This scenario is illustrated in FIG. 1 as a search query 114 that results in the identification of microblog message 106n sent by nth user 108n from the user's microblog address 112n. As a nonlimiting example, user 108n may have posted the microblog message 106n to the user's own microblog address 112n for public viewing, or sent microblog message 106n to another user's address other than microblog address 110.

As described in more detail below, server system 102 is further configured to sort incoming microblog messages into separate pools for further processing by customer support representatives, and to receive replies from such representatives for transmission to recipient customers via the designated address. Such representatives may interact with server system 102 via one or more client devices and/or client applications, as shown in FIG. 1 at 115.

Server system 102 may be configured to implement the methods and processes described herein via one or more computer applications, services, APIs (application programming interfaces), computer library, and/or other computer program products. FIG. 1 schematically shows a nonlimiting example of server system 102 in simplified form, but it is to be understood that virtually any computer architecture may be used without departing from the scope of this disclosure. In different embodiments, server system 102 may take the form of a mainframe computer, server computer, desktop computer, laptop computer, tablet computer, home entertainment computer, network computing device, mobile computing device, mobile communication device, gaming device, etc.

Server system 102 includes a logic subsystem 116 and a data-holding subsystem 118. Server system 102 may include a display subsystem 120, communication subsystem 122, and/or other components not shown in FIG. 1. Server system 102 may also optionally include user input devices such as keyboards, mice, game controllers, cameras, microphones, and/or touch screens, for example.

Logic subsystem 116 may include one or more physical devices configured to execute one or more instructions. For example, logic subsystem 116 may be configured to execute one or more instructions that are part of one or more applications, services, programs, routines, libraries, objects, components, data structures, or other logical constructs. Such instructions may be implemented to perform a task, implement a data type, transform the state of one or more devices, or otherwise arrive at a desired result.

Logic subsystem 116 may include one or more processors that are configured to execute software instructions. Additionally or alternatively, logic subsystem 116 may include one or more hardware or firmware logic machines configured to execute hardware or firmware instructions. Processors of logic subsystem 116 may be single core or multicore, and the programs executed thereon may be configured for parallel or distributed processing. Logic subsystem 116 may optionally include individual components that are distributed throughout two or more devices, which may be remotely located and/or configured for coordinated processing. One or more aspects of logic subsystem 116 may be virtualized and executed by remotely accessible networked computing devices configured in a cloud computing configuration.

Data-holding subsystem 118 may include one or more physical, non transitory, devices configured to hold data and/or instructions executable by the logic subsystem to implement the herein described methods and processes. When such methods and processes are implemented, the state of data-holding subsystem 118 may be transformed (e.g., to hold different data).

Data-holding subsystem 118 may include removable media and/or built-in devices. Data-holding subsystem 118 may include optical memory devices (e.g., CD, DVD, HD-DVD, Blu-Ray Disc, etc.), semiconductor memory devices (e.g., RAM, EPROM, EEPROM, etc.) and/or magnetic memory devices (e.g., hard disk drive, floppy disk drive, tape drive, MRAM, etc.), among others. Data-holding subsystem 118 may include devices with one or more of the following characteristics: volatile, nonvolatile, dynamic, static, read/write, read-only, random access, sequential access, location addressable, file addressable, and content addressable. In some embodiments, logic subsystem 116 and data-holding subsystem 118 may be integrated into one or more common devices, such as an application specific integrated circuit or a system on a chip.

FIG. 1 also shows an aspect of the data-holding subsystem in the form of removable computer-readable storage media 124, which may be used to store and/or transfer data and/or instructions executable to implement the herein described methods and processes. Removable computer-readable storage media 124 may take the form of CDs, DVDs, HD-DVDs, Blu-Ray Discs, EEPROMs, and/or floppy disks, among others.

When included, display subsystem 120 may be used to present a visual representation of data held by data-holding subsystem 118. As the herein described methods and processes change the data held by the data-holding subsystem, and thus transform the state of the data-holding subsystem, the state of display subsystem 120 may likewise be transformed to visually represent changes in the underlying data. Display subsystem 120 may include one or more display devices utilizing virtually any type of technology. Such display devices may be combined with logic subsystem 116 and/or data-holding subsystem 118 in a shared enclosure, or such display devices may be peripheral display devices.

Communication subsystem 122 is configured to communicatively couple server system 102 with one or more other computing devices, including but not limited to user devices 108a-n, customer support client devices 115, and network accessible servers that host microblogging service 103. Communication subsystem 122 may include wired and/or wireless communication devices compatible with one or more different communication protocols. As nonlimiting examples, the communication subsystem may be configured for communication via a wireless telephone network, a wireless local area network, a wired local area network, a wireless wide area network, a wired wide area network, etc. In some embodiments, the communication subsystem may allow server system 102 to send and/or receive messages to and/or from other devices via a network such as the Internet.

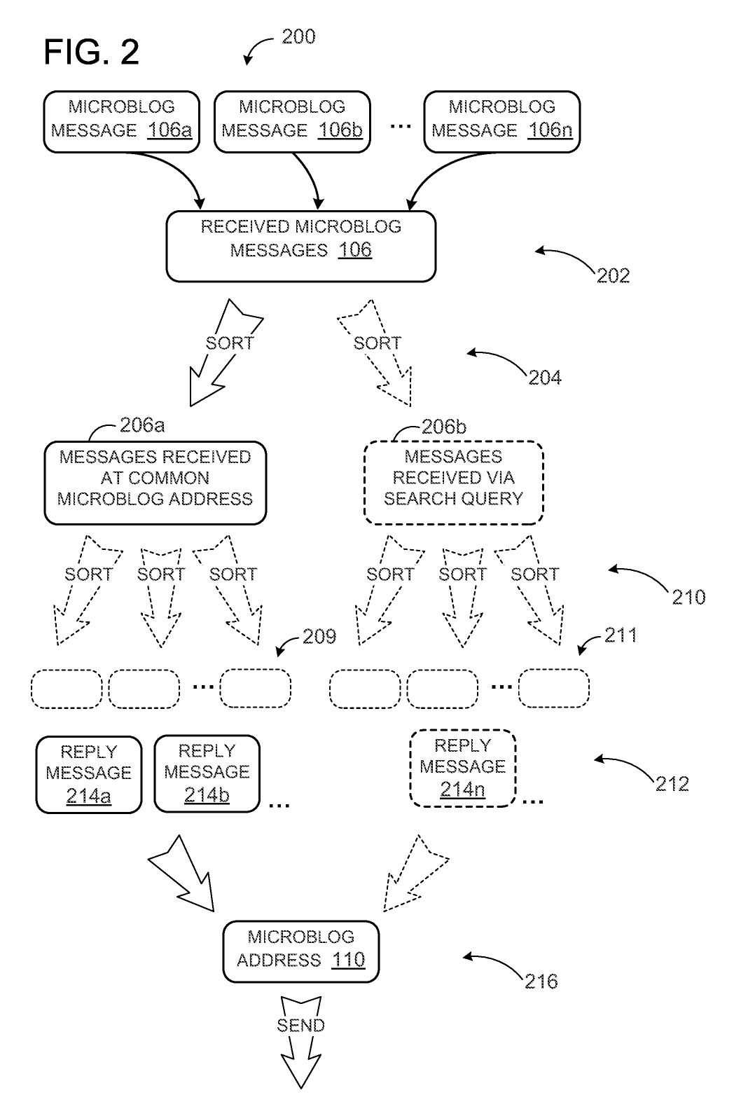

FIG. 2 illustrates an example embodiment of a method 200 for providing microblog-based customer support. At 202, the server (e.g., server system 102) receives a stream of microblog messages. As described above, such microblog messages may be received at a designated microblog address from different users. Further, in some embodiments, the server may perform searching to identify potentially relevant microblog messages posted to other microblog addresses, and therefore receive additional microblog messages via such searches.

Next, at 204, the server sorts the stream of microblog messages into one or more different pools based on preselected criteria. For example, the server may sort customer support messages received at the common microblog address into a first pool 206a, and sort search results into a different pool 206b. By sorting messages received directly at the server's microblog address from those obtained via the search query, priority may optionally be given to those sending customer support microblog messages directly.

The server may perform additional sorting, as indicated at 210. For example, the server may sort the directly-sent microblog message(s) into additional pools 209 based on a user address from which each microblog message was received, for example, based on a first letter of the address. As such, any messages received from a particular user may be sorted into the same pool, thereby allowing the pool to be searched to obtain a history associated with that user. It should be appreciated that this particular embodiment is illustrative and not intended to be limiting in any way.

As another example, the server may optionally sort the one or more microblog messages received via the search query into additional pools 211 based on keywords associated with a message found by searching. Such a search may thus allow the grouping of messages by similar selected topics, for example.

The sorting, or “push-queuing,” of received microblogging messages into different pools as shown at 204 and 210 allows for received microblog messages to be efficiently organized and optionally prioritized, thereby facilitating quick response via a reply message. Further, the server may be configured to allow the real-time dynamic adjustment of various aspects of the sorting, including but not limited to sort criteria, a number/identity of pools, etc. As such, the server can load balance and adapt to high volumes of incoming microblog messages, for example. Moreover, the server may optionally perform additional sorting to remove unwanted messages (e.g., spam messages, messages containing lewd and/or inappropriate content, etc.) and/or flag selected users for blacklisting.

At 212, the server receives one or more microblog replies, for example, from customer support representatives responding to customer inquiries (e.g., via client devices 115) from different pools of received messages. For example, the server may receive an input of a first microblog reply 214a to a first microblog message 106a of a first pool, and a second microblog reply 214b to a second microblog message 106b of a different pool. As yet another example, the server may receive an input of a microblog reply to a message received as a search result, such as example reply message 214n replying to microblog message 106n. Then, at 216, the server sends the received microblog reply messages from microblog address 110.

The use of microblog communication as described herein may be advantageous within a customer support environment. First, having a designated microblog address associated with customer support affords users a designated point of contact for receiving assistance for a variety of customer issues. This may facilitate customer interactions and customer support history tracking compared to environments in which customer support employees have personal microblog addresses, and also may help to avoid customers sending messages to addresses of employees who are out of the office, and thus help to avoid potentially slow response times.

Also, by providing a designated microblog address used by multiple customer support representatives to which users can subscribe for “follow), users may proactively keep track of issues such as major service outages, etc. This may allow a company to inform users that customer support is aware of the issue and/or the issue is being addressed, and thus the user need not contact customer support. This may help to avoid costly call volumes, etc.

In some situations, it may be possible that a maximum capacity of outgoing messages may be reached. In such a case, the server may receive an overflow notification from the microblogging service indicating a maximum allowed number of replies have been sent from the microblog address 110. In such cases, the server may then optionally send replies via a different microblog address that is still associated with customer support.

It should be appreciated that, in some embodiments, replies may be sent to a subset of received microblog messages based upon the characteristics of the message as compared to various criteria. For example, in some instances, replies may be sent to those messages received directly from customers, as opposed to those found by searching, as messages received from customers likely contain specific customer concerns for which the customer is seeking help, whereas messages received from searching may not contain such concerns.

Therefore, predetermined criteria may be used to determine whether to reply to messages found by searching. For example, a reply may be sent to a message found via searching if the person that sent a message has previously communicated with the company via microblogging (e.g., has been previously messaged) or is following the company, either by sending a message to or receiving a message from the company. Likewise, even if a person has not previously communicated with the company or is not following the designated microblogging address, the company may request to follow subsequent messages from that person's microblogging address and then send a message to the person if the found message includes content that can be effectively addressed via a response. If other cases, for example, where a found message does not contain content that can be addressed effectively in a response, then no response may be sent.

in some embodiments, a follow-up survey may be sent to a user after a reply message is sent to the user from the server. Such a follow-up survey may be used to collect customer feedback on the customer support experience, for example.

Further, in some embodiments, the server may be configured to perform back-end reporting on issue resolution to measure compliance with a service level agreement. Such reporting may include, but is not limited to, reporting customer satisfaction/dissatisfaction (CSAT/DSAT), inbound/outbound message volumes, etc.

Further yet, in some instances, a microblog message may be escalated to another party or parties within the customer support environment based upon various criteria. For example, it may be determined that the microblog message indicates a user issue not associated with the microblog-based customer support. In such a case, the user issue may be escalated to another department. As an example, a user may have an issue addressable by phone support (e.g., hardware issues, service contract/billing issues, etc.), and the user issue may then be escalated to a phone support department. As another example, a user may indicate that a service is unavailable (e.g., marketing promotion, service, content, etc.) and the issue may be escalated to the appropriate department. As yet another example, the message may indicate potential fraud, threats, etc. and may be escalated to an appropriate enforcement department.

It is to be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated may be performed in the sequence illustrated, in other sequences, in parallel, or in some cases omitted. Likewise, the order of the above-described processes may be changed.

The subject matter of the present disclosure includes all novel and nonobvious combinations and subcombinations of the various processes, systems and configurations, and other features, functions, acts, and/or properties disclosed herein, as well as any and all equivalents thereof.

1. On a server, a method of providing microblog-based customer support, the method comprising:
receiving a stream of microblog messages including two or more microblog messages received at a designated microblog address associated with customer support;
sorting the stream of microblog messages into two or more different pools based on preselected criteria;
receiving an input of a first microblog reply to a first microblog message of a first pool;
sending the first microblog reply via the designated microblog address associated with customer support;
receiving an input of a second microblog reply to a second microblog message of a second pool different than the first pool; and
sending the second microblog reply via the designated microblog address associated with customer support.

2. The method of claim 1, wherein the stream of microblog messages further includes one or more microblog messages received via searching.

3. The method of claim 2, wherein sorting the stream of microblog messages comprises sorting the two or more microblog messages received at the designated microblog address from the one or more microblog messages received via searching.

4. The method of claim 3, wherein sorting the stream of microblog messages further comprises sorting the one or more microblog messages received via searching based on a keyword search for one or more selected topics within a content of the microblog message.

5. The method of claim 3, wherein sorting the stream of microblog messages further comprises sorting the two or more microblog messages received at the designated microblog address based on a user address from which each microblog message was received.

6. The method of claim 1, wherein the first microblog message is received at the designated microblog address from a user address, and wherein sending the first microblog reply comprises sending the first microblog reply to the user address.

7. The method of claim wherein the second microblog message is received via a search query and a content of the second microblog message indicates a user issue, and wherein sending the second microblog reply comprises sending the second microblog reply to a user address corresponding to the second microblog message.

8. The method of claim 7, wherein the stream of microblog messages further includes a third microblog message received via the search query and a content of the third microblog message does not indicate a user issue, and wherein the method further comprises not sending a third microblog reply to a user address corresponding to the third microblog message.

9. The method of claim 1, further comprising:
receiving an input of a third microblog reply to a third microblog message of a third pool;
receiving an overflow notification indicating a maximum allowed number of replies sent from the designated microblog address has been reached; and
sending the third microblog reply via another microblog address associated with the server that is different than the designated microblog address.

10. A server computing device, comprising:
a logic subsystem configured to execute instructions;
a data-holding subsystem comprising instructions executable by the logic subsystem to:
receive from one or more user addresses a first plurality of microblog messages at a designated microblog address;
receive a second plurality of microblog messages based on a search query;
sort the first plurality of microblog messages into one or more first pools based on the user address of each microblog message;
sort the second plurality of microblog messages into one or more second pools based on a content of each microblog message;
receive an input of a first microblog reply to a first microblog message of a first pool of the one or more first pools;
send the first microblog reply via the designated microblog address to the user address of the first microblog message;
receive an input of a second microblog reply to a second microblog message of a second pool of the one or more second pools; and
send the second microblog reply via the designated microblog address to a user address of the second microblog message.

11. The server computing device of claim 10, wherein the instructions are executable to sort the second plurality of microblog messages based on whether or not the content of each microblog message indicates a user issue, and wherein the second microblog message indicates a user issue.

12. The server computing device of claim 10, wherein the instructions are further executable to send to the user address of the first microblog message or the second microblog address, via the designated microblog address, a follow-up customer experience survey corresponding to the first microblog reply or the second microblog reply.

13. The server computing device of claim 10, wherein the instructions are further executable to:
receive an input of a third microblog reply to a third microblog message of the first plurality of microblog messages;
receive an overflow notification indicating a maximum allowed number of replies sent from the designated microblog address has been reached; and
send the third microblog reply to the user address of the third microblog message via another microblog address associated with the server computing device that is different than the designated microblog address.

14. The server computing device of claim 10, wherein the instructions are further executable to perform back-end reporting on issue resolution to measure compliance with a service level agreement.

15. A method of providing microblog-based customer support within a customer support environment, the method comprising:
selecting a microblog message from a pool comprising one or more sorted microblog messages of a plurality of microblog messages;
if the microblog message was received at a designated microblog address, sending a microblog reply to a user address of the microblog message via the designated microblog address; and
if the microblog message was received based on a search query and the microblog message indicates a user issue, sending a microblog reply to the user address via the designated microblog address if predetermined criteria are met.

16. The method of claim 15, wherein the predetermined criteria are met if the user address has been previously messaged.

17. The method of claim 15, wherein the predetermined criteria are met if the user address has not been previously messaged but the user address is following microblog messages of customer support.

18. The method of claim 15, wherein the predetermined criteria are met if the user address has not been previously messaged and the user address is not following microblog messages of customer support, and wherein the microblog reply provides information about one or more available support services.

19. The method of claim 18, further comprising selecting to follow subsequent microblog messages sent by the user address.

20. The method of claim 15, further comprising sorting, via a server, stream of microblog messages into two or more different pools based on preselected criteria.
